(19) United States
(12) Patent Application Publication
(10) Pub. No.: US 2017/0171471 A1
(43) Pub. Date: Jun. 15, 2017

(54) METHOD AND DEVICE FOR GENERATING MULTIMEDIA PICTURE AND AN ELECTRONIC DEVICE

(71) Applicants: Le Holdings (Beijing) Co., Ltd., Beijing (CN); Lemobile Information Technology (Beijing) Co., Ltd, Beijing (CN)

(72) Inventor: Zhenyu Wang, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/245,168

(22) Filed: Aug. 23, 2016

Related U.S. Application Data
(63) Continuation of application No. PCT/CN2016/087666, filed on Jun. 29, 2016.

(30) Foreign Application Priority Data
Dec. 14, 2015 (CN) 201510927562.5

(51) Int. Cl. H04N 5/265; G06F 17/30; H04N 5/232; G06T 7/00; G06K 9/46

(52) U.S. Cl. CPC H04N 5/265; G06T 7/004; G06K 9/4604; H04N 5/23293; G06F 17/30047; G06T 2207/20144

(57) ABSTRACT

The present disclosure provides a multimedia picture generating method, device and electronic device, wherein the multimedia picture generating method includes acquiring a locational information of the location where the photographing device is located, and acquiring a picture of a photographed subject of the photographing device; extracting a figure image as a foreground image from the picture after receiving an instruction for removing picture background; searching for an image and music that matches the locational information from a multimedia database as background image and background music for the picture; and finally integrating the foreground image, the background image and the background music to generate a multimedia picture. Thus, when a user is unsatisfied with background effect of a picture that has been taken, a figure image can be automatically extracted from the picture as a foreground image, and the original background with poor effect can be removed, then an image that matches the locational information of the place of photographing can be searched out from a multimedia database as a new background image, which simplifies the optimum processing and improves the user experience.

### CROSS REFERENCE TO RELATED APPLICATIONS

This application is a continuation of International Application No. PCT/CN2016/087666 filed on Jun. 29, 2016, which is based upon and claims priority to Chinese Patent Application No. 201510927562.5 filed on Dec. 14, 2015, the entire content of which is incorporated herein by reference.

### TECHNICAL FIELD

The present disclosure relates to the field of multimedia technology, and in particular relates to a multimedia picture generating method, device and electronic device.

### BACKGROUND

Devices with photographing capability such as smart phones and tablet computers have become very good social media tools because of their functions such as convenience to carry and ability to quickly disseminate information. Along with their increasing popularity, more and more auxiliary functions have been added thereto, for instance, the photographed picture can be sent to social media platforms for sharing by means of social media software (e.g. Wechat, Microblog, QQ chat tool) built in the smart phone or tablet computer. Some smart phones and tablet computers are also provided with modules having locating functionality, such as GPS, in order to acquire the current geographic information and add it into the picture that is being taken, so that, when sharing the picture with others, others can at the same time acquire the geographic information of the place where the picture was taken.

However, sometimes because of bad weather (e.g. hazy weather) or poor photographing technique level of the photographer himself/herself, the picture that has been taken may often have relatively poor background effect. Then, if the user wants to modify the picture background, he/she needs to use a picture editing software to perform analyzing, repairing, beautifying and synthesizing on the picture. But, since the picture editing software is highly specialized and very difficult to operate, a non-professional user is required to learn and be familiar with corresponding software operation methods in order to attain a satisfactory effect, which causes poor user experience.

### SUMMARY

Therefore, the present disclosure provides a multimedia picture generating method, device and electronic device that are able to simplify the optimum processing of a picture and thus improve the user experience.

One objective of the embodiments of the present disclosure is to provide a multimedia picture generating method, including the following steps: acquiring a locational information of the location where a photographing device is located; acquiring a picture of a photographed subject of the photographing device; extracting a figure image as a foreground image from the picture after receiving an instruction for removing picture background; searching for an image and music that matches the locational information from a multimedia database as background image and background music for the picture; integrating the foreground image, the background image and the background music to generate a multimedia picture.

Another objective of the embodiments of the present disclosure is to provide a multimedia picture generating device including:

a locating apparatus for determining a locational information of the location where a photographing device is located;

a photographing apparatus for taking a picture of a photographed subject of the photographing device;

a multimedia picture generating apparatus, connected with the locating apparatus and the photographing apparatus, for receiving the locational information sent by the locating apparatus, receiving the picture sent by the photographing apparatus, extracting a figure image as a foreground image from the picture after receiving an instruction for removing picture background, searching for an image and music that matches the locational information from a multimedia database as background image and background music for the picture, and integrating the foreground image, the background image and the background music to generate a multimedia picture;

a display apparatus, connected with the photographing apparatus and the multimedia picture generating apparatus, for displaying the picture and the multimedia picture;

a player apparatus, connected with the multimedia picture generating apparatus, for playing the background music.

A further objective of the embodiments of the present disclosure is to provide an electronic device, including at least one processor; and a memory communicably connected with the at least one processor for storing instructions executable by the at least one processor, wherein execution of the instructions by the at least one processor causes the at least one processor to:

acquiring a locational information of a location where the photographing device is located; acquiring a picture of a photographed subject of the photographing device; extracting a figure image as a foreground image from the picture after receiving an instruction for removing picture background; searching for an image and music that matches the locational information from a multimedia database as background image and background music for the picture; integrating the foreground image, the background image and the background music to generate a multimedia picture.

A further objective of the embodiments of the present disclosure is to provide a non-transitory computer-readable storage medium storing executable instructions that, when executed by an electronic device, cause the electronic device to:

acquiring a locational information of a location where the photographing device is located; acquiring a picture of a photographed subject of the photographing device; extracting a figure image as a foreground image from the picture after receiving an instruction for removing picture background; searching for an image and music that matches the locational information from a multimedia database as background image and background music for the picture; integrating the foreground image, the background image and the background music to generate a multimedia picture.

The embodiments of the present disclosure provides a multimedia picture generating method, device and electronic device which acquires a locational information of the location where a photographing device is located; acquires a picture of a photographed subject of the photographing device; extracts a figure image as a foreground image from the picture after receiving an instruction for removing picture background; searches out an image and music that matches the locational information from a multimedia database as background image and background music for the picture; and finally integrates the foreground image, the background image and the background music to generate a multimedia picture. Thus, when a user is unsatisfied with background effect of a picture that has been taken, a figure image can be automatically extracted from the picture as a foreground image, and the original background with poor effect can be removed, then an image that matches the locational information of the place of photographing can be searched out from a multimedia database as a new background image, so that the user is not required to optimize the picture background by using a specialized picture editing software and instead is only required to send an instruction for removing picture background in order to replace the background with an image that matches the locational information of the place of photographing, which simplifies the optimum processing and improves the user experience. Furthermore, a music that matches the locational information can also be searched out as background music, so as to be integrated with the foreground image and the background image to generate a multimedia picture, thereby a perfect combination of visual and audial effects can be attained.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a specific example of the multimedia picture generating method in Embodiment 1 of the present disclosure;

FIG. 2 is a flow chart of a specific example of searching for an image and/or music that matches the locational information from a multimedia database in the multimedia picture generating method in Embodiment 1 of the present disclosure;

FIG. 3 is a block diagram of a specific example of the multimedia picture generating apparatus in Embodiment 2 of the present disclosure;

FIG. 4 is a block diagram of a specific example of the multimedia picture generating device in Embodiment 3 of the present disclosure;

FIG. 5 is a schematic diagram of the hardware configuration of the electronic device in Embodiment 6 of the present disclosure, which performs the multimedia picture generating method.

### REFERENCE NUMERALS

1-locational information acquisition unit; 2-original photo acquisition unit; 3-foreground image extracting unit; 4-matching unit; 5-generating unit; 6-command recognition unit; 11-locating apparatus; 12-photographing apparatus; 13-multimedia picture generating apparatus; 14-display apparatus; 15-player apparatus; 16-memory; 17-processor; 630-input apparatus; 640-output apparatus.

### DETAILED DESCRIPTION

In order to clearly describe objectives, the technical solutions and advantages of the present disclosure, a clear and complete description of the technical solutions in the present disclosure will be given below, in conjunction with the accompanying drawings in the embodiments of the present disclosure. Apparently, the embodiments described below are a part, but not all, of the embodiments of the present disclosure.

### Embodiment 1

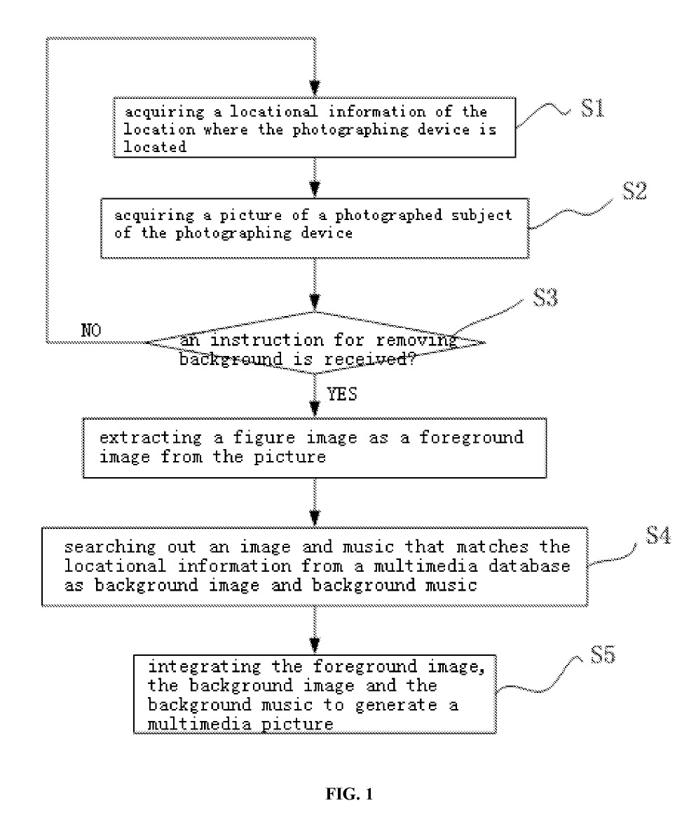

The present embodiment provides a multimedia picture generating method that is used for a photographing device, as shown in FIG. 1, the method includes the following steps:

S1, a locational information of the location where the photographing device is located is acquired. Specifically, the locational information generally includes longitude and latitude information as well as information about the located country, province, city, county, district or scenic spot. By acquiring the locational information of the location where the photographing device is located, the geographic environment of the place of photographing can be known, e.g. the photographing is done at seaside, wooded mountain, or some scenic spots and historic sites such as Mountain Tai and the Imperial Palace, which provides guidance for subsequent matching of a background image and background music with high integrating degree.

S2, a picture of a photographed subject of the photographing device is acquired.

S3, a figure image is extracted as a foreground image from the picture after receiving an instruction for removing picture background. In specific applications, contour analysis method can be used to determine the figure image in the picture and thus extract the figure image as a foreground image. Of course, any method in prior art that is able to extract a figure image from a picture can be used to implement the aforementioned operation.

S4, an image and music that matches the locational information is searched out from a multimedia database as background image and background music for the picture. In specific applications, when a picture taken by a user has unsatisfactory background effect because of bad outer environment such as hazy weather, by searching for an image and music that matches the locational information as background image and background music for the picture, the background image and background music can be made to fit the locational information of the place of photographing as closely as possible. For example, if a user is photographing at the Great Wall but the picture that has been taken has very poor background effect because of hazy weather, then by searching for an image and music that matches this locational information of the Great Wall, an image containing contents about the Great Wall as well as a music related to the Great Wall, e.g. the song “THE GREAT WALL NEVER FALL DOWN ”, can be pushed to the user, so that the background image can be made as close as possible to the real background that has been previously removed. Of course, for some natural landscapes such as seaside and forest, music demonstrating sound of the nature such as sea wave sound, streamlet flowing water sound and bird tweet sound can also be pushed to the user, so that the background music can also be made as close as possible to the content demonstrated by the picture.

S5, the foreground image, the background image and the background music are integrated to generate a multimedia picture.

By means of the multimedia picture generating method in this embodiment, when a user is unsatisfied with background effect of a picture that has been taken, a figure image can be automatically extracted from the picture as a foreground image, and the original background with poor effect can be removed, then an image that matches the locational information of the place of photographing can be searched out from a multimedia database as a new background image, so that the user is not required to optimize the picture background by using a specialized picture editing software and instead is only required to send an instruction for removing picture background in order to replace the background with an image that matches the locational information of the place of photographing, which simplifies the optimum processing and improves the user experience. Furthermore, a music that matches the locational information can also be searched out as background music, so as to be integrated with the foreground image and the background image to generate a multimedia picture, thereby a perfect combination of visual and audial effects can be attained.

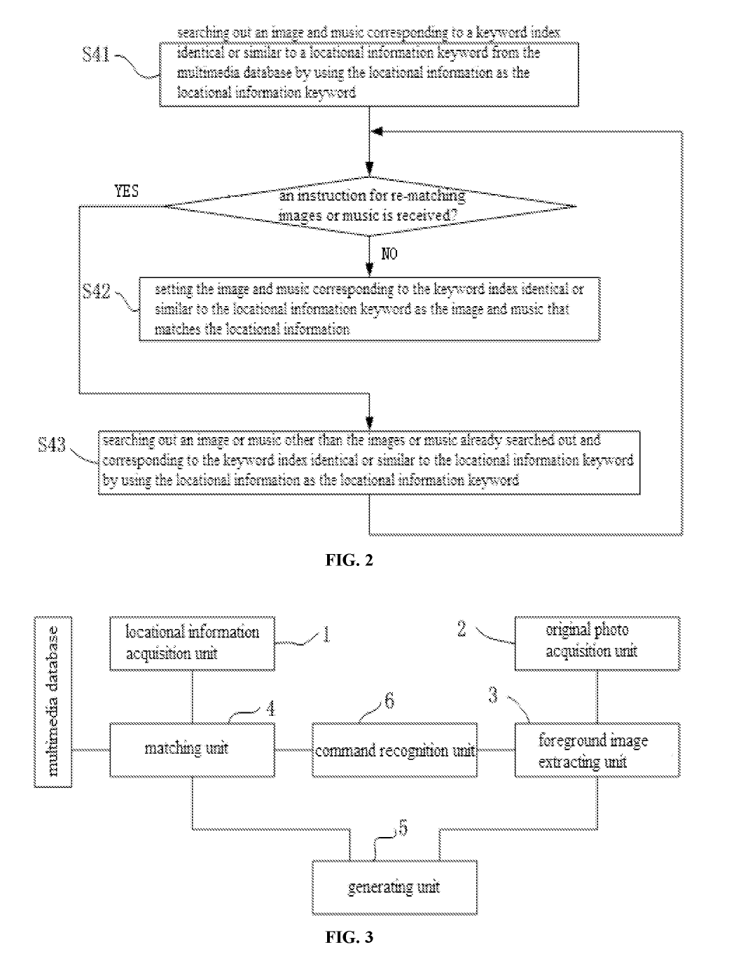

Optionally, as shown in FIG. 2, the step S4 includes:

S41, an image and music corresponding to a keyword index identical or similar to a locational information keyword is searched out from the multimedia database having keyword indexes corresponding to images and music stored therein by using the locational information as the locational information keyword. Specifically, music and images are stored with keyword indexes into the multimedia database so as to facilitate later searches. A common keyword indexing means is by using TIF formatted information, then by reading the TIF information of images and music, the content demonstrated by the images and music can be known, which is very convenient. If the keyword index corresponding to an image and music is more similar to the locational information keyword, it indicates that the content demonstrated by the image and music is more close to the geographic environment and characteristics of the place of photographing, with a higher matching degree. By searching for an image and music corresponding to a keyword index identical or similar to the locational information keyword, the image and music with the highest matching degree in relation to the locational information of the place of photographing can be ensured to be pushed to the user.

S42, if no instruction for re-searching images or music is received, the image and music corresponding to the keyword index identical or similar to the locational information keyword is set as the image and music that matches the locational information.

S43, if an instruction for re-searching images or music is received, an image or music other than the images or music already searched out and corresponding to the keyword index identical or similar to the locational information keyword is searched out from the multimedia database by using the locational information as the locational information keyword, until no further instruction for re-searching images or music is received; and then return to step S42, whereby the image and music finally searched out and corresponding to the keyword index identical or similar to the locational information keyword is set as the image and music that matches the locational information.

In the multimedia picture generating method and apparatus of the present disclosure, if the user is unsatisfied with the images or music that have been searched out, after an instruction for re-matching images or music is received, an image or music other than the images or music already searched out and corresponding to the keyword index identical or similar to the locational information keyword is searched out from the multimedia database by using the locational information as the locational information keyword, until no further instruction for re-searching images or music is received; and then the image and music finally searched out and corresponding to the keyword index identical or similar to the locational information keyword is set as the image and music that matches the locational information. This builds a foundation for generating a multimedia picture containing the foreground image, the background content and the background music that gains high user satisfaction, so as to improve the user experience, thus the image and music finally selected as the background is always satisfactory to the user, which lays a foundation for generating a multimedia picture containing the foreground image, the background content and the background music that gains high user satisfaction, so as to improve the user experience.

Optionally, the multimedia picture generating method in this embodiment performs the steps of judging whether an instruction for removing picture background is received and judging whether an instruction for re-searching images and/or music is received by recognizing user voice. Specifically, the voice recognition function can be realized by using any software with voice recognition capability in prior art. Therefore, the user is not required to manually input an instruction, and by recognizing a voice made by the user, a corresponding instruction can be acquired and a corresponding operation can be carried out according to the instruction, so that both hands of the user are freed, the user demands can be quickly responded to, and the user experience is improved.

### Embodiment 2

The present embodiment provides a multimedia picture generating apparatus, used for a photographing device, as shown in FIG. 3, the apparatus includes:

a locational information acquisition unit 1 that acquires a locational information of the location where the photographing device is located;

an original photo acquisition unit 2 that acquires a picture of a photographed subject of the photographing device;

a foreground image extracting unit 3 that extracts a figure image as a foreground image from the picture after receiving an instruction for removing picture background;

a matching unit 4 that searches out an image and music that matches the locational information from a multimedia database as background image and background music for the picture;

a generating unit 5 that integrates the foreground image, the background image and the background music to generate a multimedia picture.

By means of the multimedia picture generating apparatus in this embodiment, when a user is unsatisfied with background effect of a picture that has been taken, a figure image can be automatically extracted from the picture as a foreground image, and the original background with poor effect can be removed, then an image that matches the locational information of the place of photographing can be searched out from a multimedia database as a new background image, so that the user is not required to optimize the picture background by using a specialized picture editing software and instead is only required to send an instruction for removing picture background in order to replace the background with an image that matches the locational information of the place of photographing, which simplifies the optimum processing and improves the user experience. Furthermore, a music that matches the locational information can also be searched out as background music, so as to be integrated with the foreground image and the background image to generate a multimedia picture, thereby a perfect combination of visual and audial effects can be attained.

Optionally, the matching unit 4 retrieves keyword indexes corresponding to the contents demonstrated by images in the multimedia database; retrieves keyword indexes corresponding to the contents demonstrated by music in the multimedia database; searches out an image and music corresponding to a keyword index identical or similar to a locational information keyword from the multimedia database by using the locational information as the locational information keyword; and if no instruction for re-searching images or music is received, sets the image and music corresponding to the keyword index identical or similar to the locational information keyword as the image and music that matches the locational information.

Optionally, the matching unit 4 searches out an image or music other than the images or music already searched out and corresponding to the keyword index identical or similar to the locational information keyword from the multimedia database by using the locational information as the locational information keyword if an instruction for re-searching images or music is received, until no further instruction for re-searching images or music is received; and sets the image and music finally searched out and corresponding to the keyword index identical or similar to the locational information keyword as the image and music that matches the locational information.

The multimedia picture generating apparatus in this embodiment ensures that the image and music finally selected as the background is always satisfactory to the user, which lays a foundation for generating a multimedia picture containing the foreground image, the background content and the background music that gains high user satisfaction, so as to improve the user experience.

Optionally, the multimedia picture generating apparatus in this embodiment further includes a command recognition unit 6 that judges whether an instruction for removing picture background is received and judges whether an instruction for re-searching images or music is received by recognizing a received voice.

By means of the multimedia picture generating apparatus in this embodiment, the user is not required to manually input an instruction, and instead, by recognizing a voice made by the user, a corresponding instruction can be acquired and a corresponding operation can be carried out according to the instruction, so that both hands of the user are freed, the user demands can be quickly responded to, and the user experience is improved.

### Embodiment 3

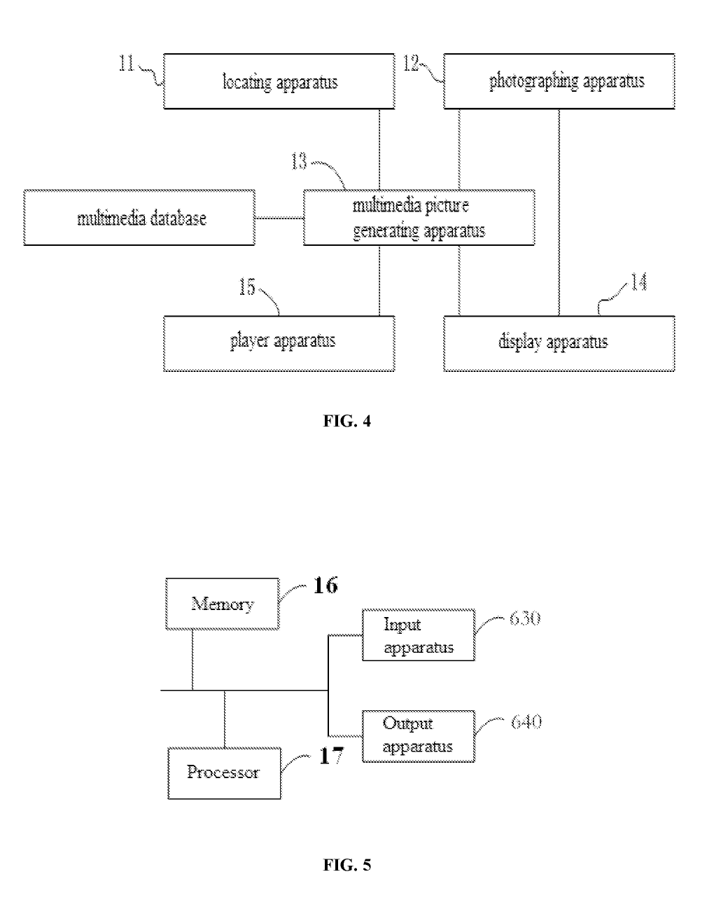

This embodiment provides a multimedia picture generating device, as shown in FIG. 4, the device includes: a locating apparatus 11, a photographing apparatus 12, the multimedia picture generating apparatus 13 as in Embodiment 2, a display apparatus 14, and a player apparatus 15.

The locating apparatus 11 determines locational information of the location where a photographing device is located. Specifically, the locating apparatus 11 may use a component with locating function such as a GPS module to determine the locational information of the location where a photographing device is located.

The photographing apparatus 12 takes a picture of a photographed subject of the photographing device. In specific applications, the photographing apparatus 12 may include components such as a camera head, a flashlight.

The multimedia picture generating apparatus 13 which is connected with the locating apparatus 11 and the photographing apparatus 12 receives the locational information sent by the locating apparatus 11, receives the picture sent by the photographing apparatus 12, extracts a figure image as a foreground image from the picture after an instruction for removing picture background is received, searches out an image and music that matches the locational information from a multimedia database as background image and background music for the picture, and integrates the foreground image, the background image and the background music to generate a multimedia picture. In specific applications, the multimedia picture generating apparatus 13 may be a controller with built-in programs that can perform the steps in Embodiment 1, so as to achieve automatic optimum processing of a picture. Specifically, the multimedia picture generating apparatus 13 has access to a multimedia database in the memory of the photographing device, and also has access to a multimedia database stored in devices other than the photographing device, which provides technical support for searching for an image and music that satisfies the user demand.

The display apparatus 14 which is connected with the photographing apparatus 12 and the multimedia picture generating apparatus 13 displays the picture and the multimedia picture. Specifically, the display apparatus 14 may be a display screen which presents the photographed picture to the user in order for the user to timely determine whether the background thereof needs to be removed, presents the image that has been searched out to the user in order for the user to timely determine if the image needs to be re-matched, and also allows the user to instantaneously enjoy the multimedia picture that has been optimized and generated.

The player apparatus 15 which is connected with the multimedia picture generating apparatus 13 plays the background music. Specifically, the player apparatus 15 may be a micro-electronic loudspeaker which plays the music that has been searched out to the user in order for the user to timely determine whether the music needs to be re-matched, and also allows the user to instantaneously enjoy the background music in the multimedia picture.

With the multimedia picture generating device in this embodiment, when a user is unsatisfied with background effect of a picture that has been taken, by using the multimedia picture generating apparatus 13 thereof, a figure image can be automatically extracted from the picture as a foreground image, and the original background with poor effect can be removed, then an image that matches the locational information of the place of photographing can be searched out from a multimedia database as a new background image, so that the user is not required to optimize the picture background by using a specialized picture editing software and instead is only required to send an instruction for removing picture background in order to replace the background with an image that matches the locational information of the place of photographing, which simplifies the optimum processing and improves the user experience. Furthermore, a music that matches the locational information can also be searched out as background music, so as to be integrated with the foreground image and the background image to generate a multimedia picture, thereby a perfect combination of visual and audial effects can be attained. Meanwhile, the user is not required to manually input an instruction, and by recognizing a voice made by the user, a corresponding instruction can be acquired and a corresponding operation can be carried out according to the instruction, so that both hands of the user are freed, the user demands can be quickly responded to, and the user experience is improved.

### Embodiment 4

The present embodiment provides a cell phone including the multimedia picture generating apparatus in Embodiment 2 or including the multimedia picture generating device in Embodiment 3.

By means of the cell phone in this embodiment, when a user is unsatisfied with background effect of a picture that has been taken, a figure image can be automatically extracted from the picture as a foreground image, and the original background with poor effect can be removed, then an image that matches the locational information of the place of photographing can be searched out from a multimedia database as a new background image, so that the user is not required to optimize the picture background by using a specialized picture editing software and instead is only required to send an instruction for removing picture background in order to replace the background with an image that matches the locational information of the place of photographing, which simplifies the optimum processing and improves the user experience. Furthermore, a music that matches the locational information can also be searched out as background music, so as to be integrated with the foreground image and the background image to generate a multimedia picture, thereby a perfect combination of visual and audial effects can be attained. Meanwhile, the user is not required to manually input an instruction, and by recognizing a voice made by the user, a corresponding instruction can be acquired and a corresponding operation can be carried out according to the instruction, so that both hands of the user are freed, the user demands can be quickly responded to, and the user experience is improved.

### Embodiment 5

The present embodiment provides a non-transitory computer-readable storage medium storing executable instructions that, when executed by an electronic device, cause the electronic device to perform the multimedia picture generating method of any one of the above-mentioned method embodiments.

### Embodiment 6

FIG. 5 is a schematic diagram of the hardware configuration of the electronic device provided by the present embodiment, which performs the multimedia picture generating method. As shown in FIG. 5, the electronic device includes: one or more processors 17 and a memory 16, wherein one processor 17 is shown in FIG. 5 as an example. The electronic device that performs the multimedia picture generating method further includes: an input apparatus 630 and an output apparatus 640.

The processor 17, the memory 16, the input apparatus 630 and the output apparatus 640 may be connected via a bus line or other means, wherein connection via a bus line is shown in FIG. 5 as an example.

The memory 16 is a non-transitory computer-readable storage medium that can be used to store non-transitory software programs, non-transitory computer-executable programs and modules, such as the program instructions/modules corresponding to the multimedia picture generating method of the embodiments of the present disclosure (e.g. the locational information acquisition unit 1, the original photo acquisition unit 2, the foreground image extracting unit 3, the matching unit 4 and the generating unit 5 shown in FIG. 3). The processor 17 executes the non-transitory software programs, instructions and modules stored in the memory 16 so as to perform various function application and data processing of the server, thereby implementing the multimedia picture generating method of the above-mentioned method embodiments

The memory 16 includes a program storage area and a data storage area, wherein the program storage area can store an operation system and application programs required for at least one function; the data storage area can store data generated by use of the multimedia picture generating device. Furthermore, the memory 16 may include a high-speed random access memory, and may also include a non-volatile memory, e.g. at least one magnetic disk memory unit, flash memory unit, or other non-volatile solid-state memory unit. In some embodiments, optionally, the memory 16 includes a remote memory accessed by the processor 17, and the remote memory is connected to the multimedia picture generating device via network connection. Examples of the aforementioned network include but not limited to internet, intranet, LAN, GSM, and their combinations.

The input apparatus 630 receives digit or character information, so as to generate signal input related to the user configuration and function control of the multimedia picture generating device. The output apparatus 640 includes display devices such as a display screen.

The one or more modules are stored in the memory 620 and, when executed by the one or more processors 610, perform the multimedia picture generating method of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

1. A multimedia picture generating method, comprising the following steps:
acquiring a locational information of a location where the photographing device is located;
acquiring a picture of a photographed subject of the photographing device;
extracting a figure image as a foreground image from the picture after receiving an instruction for removing picture background;
searching for an image and music that matches the locational information from a multimedia database as background image and background music for the picture;
integrating the foreground image, the background image and the background music to generate a multimedia picture.

2. The multimedia picture generating method of claim 1, wherein the step of searching for an image and music that matches the locational information from a multimedia database as background image and background music for the picture comprises:
searching for an image and music corresponding to a keyword index identical or similar to a locational information keyword from the multimedia database having keyword indexes corresponding to images and music stored therein by using the locational information as the locational information keyword;
if no instruction for re-searching images or music is received, setting the image and music corresponding to the keyword index identical or similar to the locational information keyword as the image and music that matches the locational information.

3. The multimedia picture generating method of claim 2, wherein after the step of searching for an image and music corresponding to a keyword index identical or similar to the locational information keyword from the multimedia database by using the locational information as the locational information keyword, the method further comprises:
if an instruction for re-searching images or music is received, searching for an image or music other than the images or music already searched out and corresponding to the keyword index identical or similar to the locational information keyword from the multimedia database by using the locational information as the locational information keyword, until no further instruction for re-searching images or music is received;
setting the image and music finally searched out and corresponding to the keyword index identical or similar to the locational information keyword as the image and music that matches the locational information.

4. The multimedia picture generating method of claim 1, wherein the steps of judging whether an instruction for removing picture background is received and judging whether an instruction for re-searching images or music is received are performed by recognizing a received voice.

5. The electronic device according to claim 6, further comprising:
a locating apparatus (11) for determining the locational information of the location where the photographing device is located;
a photographing apparatus (12) for taking the picture of the photographed subject of the photographing device;
a multimedia picture generating apparatus (13), connected with the locating apparatus (11) and the photographing apparatus (12), for receiving the locational information sent by the locating apparatus (11), receiving the picture sent by the photographing apparatus (12), extracting the figure image as the foreground image from the picture after receiving an instruction for removing picture background, searching for the image and music that matches the locational information from the multimedia database as background image and background music for the picture, and integrating the foreground image, the background image and the background music to generate the multimedia picture;
a display apparatus (14), connected with the photographing apparatus (12) and the multimedia picture generating apparatus (13), for displaying the picture and the multimedia picture;
a player apparatus (15), connected with the multimedia picture generating apparatus (13), for playing the background music.

6. An electronic device, comprising:
at least one processor; and
a memory communicably connected with the at least one processor for storing instructions executable by the at least one processor, wherein execution of the instructions by the at least one processor causes the at least one processor to:
acquiring a locational information of the location where a photographing device is located;
acquiring a picture of a photographed subject of the photographing device;
extracting a figure image as a foreground image from the picture after receiving an instruction for removing picture background;
searching for an image and music that matches the locational information from a multimedia database as background image and background music for the picture;
integrating the foreground image, the background image and the background music to generate a multimedia picture.

7. The electronic device of claim 6, wherein searching for an image and music that matches the locational information from a multimedia database as background image and background music for the picture comprises:
searching for an image and music corresponding to a keyword index identical or similar to a locational information keyword from the multimedia database having keyword indexes corresponding to images and music stored therein by using the locational information as the locational information keyword;
if no instruction for re-searching images or music is received, setting the image and music corresponding to the keyword index identical or similar to the locational information keyword as the image and music that matches the locational information.

8. The electronic device of claim 7, wherein after searching for an image and music corresponding to a keyword index identical or similar to the locational information keyword from the multimedia database by using the locational information as the locational information keyword, the at least one processor is further caused to:
if an instruction for re-searching images or music is received, searching for an image or music other than the images or music already searched out and corresponding to the keyword index identical or similar to the locational information keyword from the multimedia database by using the locational information as the locational information keyword, until no further instruction for re-searching images or music is received;
setting the image and music finally searched out and corresponding to the keyword index identical or similar to the locational information keyword as the image and music that matches the locational information.

9. The electronic device of claim 6, wherein judging whether an instruction for removing picture background is received and judging whether an instruction for re-searching images or music is received are performed by recognizing a received voice.

10. A non-transitory computer-readable storage medium storing executable instructions that, when executed by an electronic device, cause the electronic device to:
acquiring a locational information of the location where a photographing device is located;
acquiring a picture of a photographed subject of the photographing device;
extracting a figure image as a foreground image from the picture after receiving an instruction for removing picture background;
searching for an image and music that matches the locational information from a multimedia database as background image and background music for the picture;
integrating the foreground image, the background image and the background music to generate a multimedia picture.

11. The non-transitory computer-readable storage medium of claim 10, wherein searching for an image and music that matches the locational information from a multimedia database as background image and background music for the picture comprises:
searching for an image and music corresponding to a keyword index identical or similar to a locational information keyword from the multimedia database having keyword indexes corresponding to images and music stored therein by using the locational information as the locational information keyword;
if no instruction for re-searching images or music is received, setting the image and music corresponding to the keyword index identical or similar to the locational information keyword as the image and music that matches the locational information.

12. The non-transitory computer-readable storage medium of claim 11, wherein after searching for an image and music corresponding to a keyword index identical or similar to the locational information keyword from the multimedia database by using the locational information as the locational information keyword, the electronic device is further caused to:
if an instruction for re-searching images or music is received, searching for an image or music other than the images or music already searched out and corresponding to the keyword index identical or similar to the locational information keyword from the multimedia database by using the locational information as the locational information keyword, until no further instruction for re-searching images or music is received;
setting the image and music finally searched out and corresponding to the keyword index identical or similar to the locational information keyword as the image and music that matches the locational information.

13. The non-transitory computer-readable storage medium of claim 10, wherein judging whether an instruction for removing picture background is received and judging whether an instruction for re-searching images or music is received are performed by recognizing a received voice.
